(19) United States
(12) Patent Application Publication
(10) Pub. No.: US 2026/0260422 A1
(43) Pub. Date: Sep. 3, 2026

(54) External Display System, A Display Device, A Controlling Method and A Storage Medium

(71) Applicant: GravityXR Electronics & Technology Co., Ltd., Ningbo (CN)

(72) Inventors: Xuanbai AN, Ningbo (CN); Miao LI, Ningbo (CN); Wen XU, Ningbo (CN)

(21) Appl. No.: 19/653,447

(22) Filed: Apr. 21, 2026

Related U.S. Application Data
(63) Continuation-in-part of application No. PCT/CN2024/126345, filed on Oct. 22, 2024.

(30) Foreign Application Priority Data
Oct. 23, 2023 (CN) 202311371637.7

(51) Int. Cl. G06T 17/10; G06V 40/16

(52) U.S. Cl. CPC G06T 17/10; G06V 40/168; G06V 40/176

(57) ABSTRACT

An external display system, a display device, a controlling method, and a non-transitory computer-readable storage medium are provided. The external display system comprises a facial image generator, a display image generator, a layer mixer and an external display screen. The facial image generator is used to obtain facial data of a user to generate a facial image. The display image generator is used to generate an externally displayed image. The layer mixer is used to perform layer mixing on the facial image and the externally displayed image according to depth and transparency, to generate a mixed image. The external display screen is used to externally display the mixed image.

### RELATED APPLICATIONS

This application is a continuation-in-part of, and claims benefit to, International Patent Application No. PCT/CN2024/126345, filed on Oct. 22, 2024, titled “An external display system, a head mounted display device, a controlling method and a storage medium”, which claims priority of Chinese Patent Application No. 202311371637.7, filed on Oct. 23, 2023, titled “An external display system, a head mounted display device, a controlling method and a storage medium”, each of which is incorporated by reference in its entirety.

### TECHNICAL FIELD

The disclosure relates to the field of external display technology, in particular to an external display system, a display device, a controlling method, and a computer-readable storage medium.

### BACKGROUND

In recent years, new virtual reality (VR) and mixed reality (MR) head mounted display devices have continuously appeared on the market. However, the prior head mounted display devices generally focus on internal display for a wearer, and are unable to display images to external individuals, which is not conducive to communication between the wearer and the external individuals regarding contents of the images. In addition, since the prior head mounted display devices generally adopt an opaque and closed appearance, which will greatly block the face of the wearer, it will not only affect the aesthetic appearance when the wearer wears them, but also hinder the external individuals from observing the countenance of the wearer, thus causing inconvenience in communication between the wearer and the external individuals.

In order to overcome the above-mentioned shortcomings of prior arts, this field urgently needs an external display technology, that can externally display the contents to facilitate communication and interaction between the external individuals and the wearer, in addition to head mounted display devices, the disclosure disclosed herein can also be applied to robots, digital humans, or other systems or devices used for externally expressing facial images and displaying contents.

### SUMMARY

A brief overview of one or more aspects is provided below to provide a basic understanding of these aspects. The summary is not an extensive overview of all of the aspects that are contemplated, and is not intended to identify key or decisive elements in all aspects. The sole purpose of the summary is to present some concepts of one or more aspects in a simplified form as a prelude to the more detailed description that is presented later.

In order to overcome the above-mentioned shortcomings of prior arts, the disclosure provides an external display system, a display device, a controlling method for the display device, and a non-transitory computer-readable storage medium, which can enable external individuals to see facial countenances of a wearer and corresponding display contents at the same time by externally displaying a mixed image of a face of the wearer and display contents, thereby facilitating communication and interaction between external individuals and the wearer.

Specifically, according to the external display system provided in the first aspect of the disclosure comprises a facial image generator, a display image generator, a layer mixer and an external display screen. The facial image generator obtains facial data of a user to generate a facial image. The display image generator is used to generate an externally displayed image. The layer mixer is used to perform layer mixing on the facial image and the externally displayed image according to depth and transparency, to generate a mixed image. The external display screen is used to externally display the mixed image.

Furthermore, in some embodiments of the disclosure, the facial image generator is connected to at least one image sensor and at least one depth sensor. The image sensor is oriented towards face of the user, to collect image data of the face of the user. The depth sensor is oriented towards the face of the user, to collect first depth data of the face of the user. The facial image generator generates a 3D facial image with depth information, according to the image data and the first depth data of the face of the user.

Furthermore, in some embodiments of the disclosure, the facial image generator is further configured with a first interpolation table. The facial image generator is further configured to: interpolate a 3D facial image from a single view angle according to the first interpolation table, to obtain 3D facial images from a plurality of view angles; and transfer the 3D facial images from the plurality of view angles to the layer mixer, to separately perform layer mixing with the externally displayed image from a corresponding view angle.

Furthermore, in some embodiments of the disclosure, the first interpolation table is divided by triangular meshes, and stores texture coordinates, spatial coordinates and mesh information of a plurality of mesh vertices. The interpolate a 3D facial image from a single view angle according to the first interpolation table, to obtain 3D facial images from a plurality of view angles comprises: separately determine a corresponding triangular mesh for each of a plurality of first pixel points in the 3D facial image from the single view angle, according to pixel indices of the plurality of first pixel points, and the spatial coordinates and the mesh information of each of the plurality of mesh vertices stored in the first interpolation table; perform triangular interpolation, according to the texture coordinates of the mesh vertices of each of the triangular meshes, and relative positions between each of the plurality of first pixel points and corresponding mesh vertices, to separately determine the texture coordinates of a plurality of second pixel points in each of the triangular meshes from the corresponding view angle; and separately determine the 3D facial image from the corresponding view angle, according to the texture coordinates of the plurality of first pixel points and the plurality of second pixel points from the plurality of the view angles.

Furthermore, in some embodiments of the disclosure, the externally displayed image comprises a 3D virtual object image with depth information. The display image generator is configured to generate a virtual object image to be displayed, determine corresponding second depth data thereof, and generate the 3D virtual object image according to the virtual object image to be displayed and the second depth data, the layer mixer is configured to perform layer mixing on a 2D or 3D facial image and the 3D virtual object image according to depth and transparency, to generate the mixed image.

Furthermore, in some embodiments of the disclosure, the display image generator is further configured with a second interpolation table corresponding to the 3D virtual object image. The display image generator is further configured to: interpolate the 3D virtual object image from a single view angle according to the second interpolation table, to obtain 3D virtual object images from a plurality of view angles.

Furthermore, in some embodiments of the disclosure, the layer mixer is configured with a first lookup table corresponding to first depth of the 3D facial image, and a second lookup table corresponding to second depth of the 3D virtual object image, and is configured to: perform layer mixing based on depths of the 3D facial image and the 3D virtual object image, according to the first lookup table and the second lookup table, adjusting display content and display position of the 3D facial image and/or the 3D virtual object image, to generate a 2D mixed image with 3D visual effect.

Furthermore, in some embodiments of the disclosure, the external display screen is configured with a microlens array composed of a plurality of microlens units, and is configured to: obtain 3D facial images from a plurality of view angles, and 3D virtual object images from a plurality of view angles; and control light emitted to corresponding directions by each pixel unit in the external display screen according to the view angles of each of the 3D facial images and each of the 3D virtual object images, via the microlens array, to display a corresponding mixed image to a direction of each of the plurality of view angles.

Furthermore, in some embodiments of the disclosure, the plurality of microlens units are cylindrical, and a long side direction thereof is different from a column direction of the pixel units of the external display screen, and each of the microlens units corresponds to a non-integer number of the pixel units.

Furthermore, in some embodiments of the disclosure, the external display system further comprises a feedback unit, used to sense an audience position of at least one external audience, and adjust a display mode of the mixed image according to an audience position of the at least one external audience.

Furthermore, in some embodiments of the disclosure, the display image generator is configured to: determine a first expression feature of a corresponding virtual object based on a current interaction scene, wherein the first expression feature comprises at least one of a virtual object category feature and a display effect feature; and generate the virtual object image corresponding to the current interactive scene, according to the first expression feature.

Furthermore, in some embodiments of the disclosure, the external display system further comprises an emotion recognizer. The emotion recognizer is configured to determine an emotion of the user according to the current interaction scene. The facial image generator is configured to determine a second expression feature of the facial image according to the emotion of the user, and generate the facial image of the user according to the facial data of the user and the second expression feature, wherein the second expression feature comprises at least one of an emotion feature and an countenance feature, the display image generating module is further configured to determine the first expression feature corresponding to the emotion of the user according to the current interaction scene, and generate the virtual object image associated with the second expression feature of the facial image according to the first expression feature.

Furthermore, in some embodiments of the disclosure, the external display screen is located on an outer side of a head mounted display device, and faces away from the face of the user wearing the head mounted display device, to externally display the mixed image. The externally displayed image comprises a mirrored 2D user interface image. The display image generator is configured to: obtain internal display data displayed to the user of the head mounted display device, and perform mirroring processing on the internal display data to generate the mirrored 2D user interface image. The layer mixer is configured to: perform layer mixing on a 2D or 3D facial image and the mirrored 2D user interface image according to depth and transparency to generate the mixed image.

Furthermore, in some embodiments of the disclosure, the externally displayed image further comprises a 3D virtual object image with depth information. The perform layer mixing on a 2D or 3D facial image and the mirrored 2D user interface image according to depth and transparency to generate the mixed image comprises: obtain the 3D virtual object image, as well as a second depth and a second transparency thereof; obtain the mirrored 2D user interface image, as well as a third transparency thereof and a third depth corresponding to the external display screen; and perform layer mixing on the facial image, the 3D virtual object image and the mirrored 2D user interface image, according to a first depth corresponding to the facial image, the second depth, the second transparency, the third depth, and the third transparency.

Furthermore, in some embodiments of the disclosure, the layer mixer is further connected to an ambient light sensor, and is further configured to: determine a second brightness of a second layer where the 3D virtual object image are located; determine a third brightness of a third layer where the mirrored 2D user interface image are located; obtain an ambient light signal via the ambient light sensor; determine a first brightness of a first layer where the facial image is located according to the ambient light signal, adjust the second brightness to determine a second corrected brightness, and adjust the third brightness to determine a third corrected brightness; and perform layer mixing on the facial image, the 3D virtual object image and the mirrored 2D user interface image, according to the first brightness, the second corrected brightness and the third corrected brightness, to generate the mixed image.

Furthermore, in some embodiments of the disclosure, the determine a first brightness of a first layer where the facial image is located according to the ambient light signal comprises: determine a first brightness adjustment coefficient, according to the ambient light signal and a reflection coefficient; and determine the first brightness of the first layer where the facial image is located through multiplication operation, by combining an image brightness captured by a camera.

Furthermore, in some embodiments of the disclosure, the layer mixer is further configured to: determine a first occlusion attenuation coefficient of the third layer for the first layer, according to the third transparency of the third layer; determine a second occlusion attenuation coefficient of the second layer for the first layer, and a third occlusion attenuation coefficient of the second layer for the third layer, according to the second transparency of the second layer; determine a first adjustment value of the first layer, a second adjustment value of the second layer and a third adjustment value of the third layer, according to the ambient light signal, the first occlusion attenuation coefficient, the second occlusion attenuation coefficient and the third occlusion attenuation coefficient; in response to generation of the mixed image, determine whether a maximum brightness of the mixed image is greater than a maximum display brightness of the external display screen; and in response to a judgment result that the maximum brightness of the mixed image is greater than the maximum display brightness of the external display screen, determine a tone mapping value according to a ratio of the maximum brightness of the mixed image to the maximum display brightness of the external display screen, and perform color tone mapping on RGB grayscale values of each pixel in the mixed image, according to the tone mapping value, the first adjustment value, the second adjustment value and the third adjustment value, so as to make the maximum brightness value less than or equal to the maximum display brightness of the external display screen.

Furthermore, in some embodiments of the disclosure, the facial image is a static facial image, or a dynamic facial countenance image.

Furthermore, in some embodiments of the disclosure, the facial image generator is further configured to: perform pre-modeling of the face of the user, by pre-collecting and storing first depth data from each position of the face of the user to the external display screen; and update the facial image of the user, by performing facial countenance tracking in combination with real-time collected facial image data.

In addition, according to the display device provided in the second aspect of the disclosure comprises an internal display system and the external display system provided in the first aspect of the disclosure. The internal display system comprises an internal display screen, used to display a virtual reality image, generated by the internal display system, to a first user wearing the head mounted display device. The external display system comprises an external display screen, used to display a mixed image of a facial image of the first user and an internal display image displayed on the internal display screen, to a second user facing the first user.

In addition, according to the controlling method provided in the third aspect of the disclosure comprises: obtaining facial data of a user to generate a facial image; generating an externally displayed image; performing layer mixing on the facial image and the externally displayed image according to depth and transparency, to generate a mixed image; and externally displaying the mixed image via an external display screen.

In addition, according to the non-transitory computer-readable storage medium provided in the forth aspect of the disclosure in which a computer instruction is stored, wherein when the computer instruction is executed by a processor, the controlling method provided in the third aspect of the disclosure is implemented.

### BRIEF DESCRIPTION OF THE DRAWINGS

The above features and advantages of the disclosure will be better understood after reading the detailed description of the embodiments of the present disclosure in conjunction with the following figures. In the figures, components are not necessarily drawn to scale, and components having similar related features may have the same or similar reference numerals.

FIG. 1 shows a schematic architecture of a head mounted display device provided according to some embodiments of the disclosure.

FIG. 2 shows a flowchart of a controlling method for a head mounted display device provided according to some embodiments of the disclosure.

FIG. 3 shows a schematic diagram of facial depth provided according to some embodiments of the disclosure.

FIG. 4 shows a schematic diagram of a facial image divided by triangular meshes provided according to some embodiments of the disclosure.

FIG. 5 shows a schematic diagram of generating a mirrored externally displayed image provided according to some embodiments of the disclosure.

FIG. 6A and FIG. 6B show schematic diagrams of three-dimensional objects provided according to some embodiments of the disclosure.

FIG. 7A to FIG. 7C show schematic diagrams of a mixed image provided according to some embodiments of the disclosure.

FIG. 8 shows a schematic diagram of pixel-level layer mixing provided according to some embodiments of the disclosure.

FIG. 9 shows a schematic diagram of an external display screen with a plurality of view angles display provided according to some embodiments of the disclosure.

FIG. 10 shows a schematic diagram of microlens array units provided according to some embodiments of the disclosure.

FIG. 11 shows a schematic diagram of a plurality of view angles display provided according to some embodiments of the disclosure.

FIG. 12 shows a schematic diagram of an external display system provided according to some embodiments of the disclosure.

FIG. 13 shows a schematic diagram of an external display scene provided according to some embodiments of the disclosure.

FIG. 14 shows a flowchart of a controlling method for an external display system provided according to some embodiments of the disclosure.

### DETAILED DESCRIPTION OF EMBODIMENTS

The implementations of the disclosure are described below by specific embodiments. Those skilled in the art can easily understand other advantages and effects of the disclosure from the contents disclosed in the description. Although the description of the disclosure is introduced together with preferred embodiments, it does not mean that the features of the disclosure are limited to the embodiments. On the contrary, the purpose of introducing the disclosure in combination with the embodiments is to cover other options or modifications that may be extended based on the claims of the disclosure. In order to provide a deep understanding of the disclosure, the following description will contain many specific details. The disclosure can also be implemented without using these details. In addition, in order to avoid confusion or ambiguity of the key points of the disclosure, some specific details are omitted in the description.

In the description of the disclosure, it should be noted that, unless otherwise specified and defined, the terms “installation”, “connecting” and “connection” should be understood in a broad sense. For example, they can be fixed connection, removable connection or integrated connection; mechanical connection or electrical connection; as well as direct connection, indirect connection through intermediate media or internal connection of two components. For those skilled in the art, the specific meaning of the above terms in the disclosure can be understood in specific cases.

In addition, the words “up”, “down”, “left”, “right”, “top”, “bottom”, “horizontal” and “vertical” used in the following description should be understood as the orientation shown in this paragraph and the relevant drawings. This relative term is only for convenience of explanation, and does not mean that the described device needs to be manufactured or operated in a specific direction, so it should not be understood as a limitation of the disclosure.

It is understood that although the terms “first”, “second”, “third”, etc. can be used here to describe various components, regions, layers and/or parts, these components, regions, layers and/or parts should not be limited by these terms, and these terms are only used to distinguish different components, regions, layers and/or parts. Therefore, a first component, area, layer and/or part discussed below can be referred to as a second component, area, layer and/or part without departing from some embodiments of the disclosure.

As mentioned above, prior virtual reality (VR) and mixed reality (MR) head mounted display devices generally cannot allow external individuals to understand the scenes seen by a user, which is not conducive to communication between the user and the external individuals regarding screen contents. In addition, since the prior head mounted display devices generally adopt an opaque and closed appearance, which will greatly block a face of the user, it will not only affect the aesthetic appearance when the user wears them, but also hinders the external individuals from observing the countenance of the user, thus causing inconvenience in communication between the user and the external individuals.

In order to overcome the above-mentioned shortcomings of prior arts, the disclosure provides an external display system, a head mounted display device, a controlling method for the head mounted display device, and a non-transitory computer-readable storage medium, which can enable external individuals to see facial countenances of a wearer and corresponding display contents at the same time by externally displaying a mixed image of a face of the wearer and display contents, thereby facilitating communication and interaction between external individuals and the wearer.

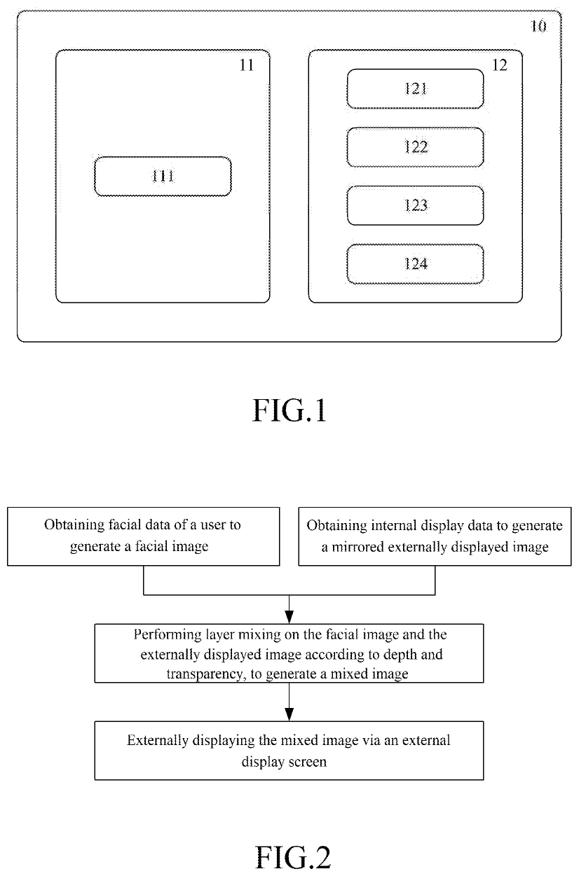

In some non-limiting embodiments, the controlling method for the above-mentioned head mounted display device provided in the third aspect of the disclosure can be implemented by the above-mentioned head mounted display device provided in the second aspect of the disclosure. Please refer to FIG. 1 for details, FIG. 1 shows a schematic architecture of a head mounted display device provided according to some embodiments of the disclosure.

As shown in FIG. 1, the head mounted display device 10 provided in the second aspect of the disclosure can be configured with an internal display system 11, and the external display system 12 provided in the first aspect of the disclosure. The internal display system 11 can comprise an internal display screen 11. The internal display screen 11 is located on the inner side of the head mounted display device 10 and faces a first user wearing the head mounted display device 10, to display a virtual reality image, generated by the internal display system 11 to the first user. In addition, the external display system 12 can comprise a facial image generator 121, a display image generator 122, a layer mixer 123, and an external display screen 124. The facial image generator 121 is used to obtain facial data of the first user wearing the head mounted display device 10, to generate a facial image. Herein, the facial image is a static facial image, or a dynamic facial countenance image. The display image generator 122 is used to obtain internal display data from the internal display system 11 of the head mounted display device 10, and generate a corresponding externally displayed image. The layer mixer 123 is used to perform layer mixing on the facial image and the externally displayed image according to depth and transparency, to generate a mixed image. The external display screen 124 is located on the outer side of the head mounted display device 10, facing away from the face of the first user, to display the mixed image to an external second user. Herein, the external display screen 124 can be either a flat screen or a curved screen.

In addition, in some non-limiting embodiments, the external display system 12 provided in the first aspect of the disclosure can also be configured with a memory and a processor. The memory includes, but is not limited to, the computer-readable storage medium provided in the fourth aspect of the disclosure, on which computer instructions are stored. The processor is connected to the memory and configured to execute the computer instructions stored on the memory, to implement the above-mentioned controlling method for the head mounted display device provided in the third aspect of the disclosure.

The working principle of the head mounted display device 10 will be described below in conjunction with some embodiments of some controlling methods. Those skilled in the art can understand that the embodiments of these controlling methods only provide some non-limiting implementations of the disclosure, which is intended to clearly display the main idea of the disclosure, and provide some specific proposals that are convenient for the public to implement, rather than limiting all working modes or all functions of the head mounted display device 10. Similarly, the head mounted display device 10 is only a non-limiting embodiment provided by the disclosure, and does not limit the implementation subject to each step in these controlling methods.

Please refer to FIG. 1 and FIG. 2, FIG. 2 shows a flowchart of a controlling method for a head mounted display device provided according to some embodiments of the disclosure.

As shown in FIG. 1 and FIG. 2, during the process of externally displaying the mixed image, the external display system can firstly obtain the facial data of a user to generate a facial image through the facial image generator 121 to generate a facial image, and obtain the internal display data of the head mounted display device 10 from the internal display system 11 through the image generator 122 to generate the corresponding externally displayed image.

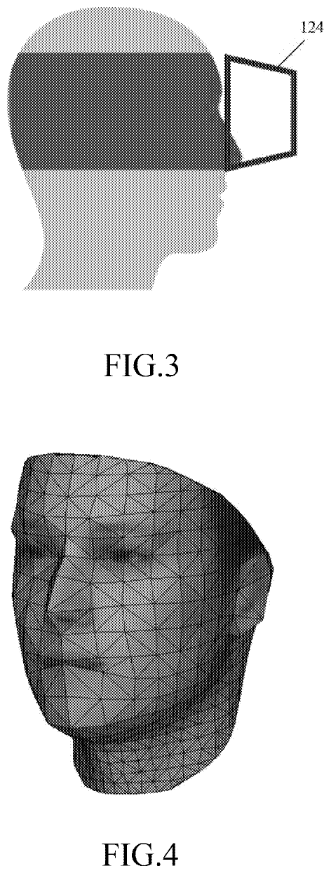

Please refer to FIG. 3 for details, FIG. 3 shows a schematic diagram of facial depth provided according to some embodiments of the disclosure.

In the embodiments shown in FIG. 3, the facial image generator 121 is connected to at least one image sensor and at least one depth sensor. During the generation of the facial image, the facial image generator 121 can firstly obtain image data of face of the first user and first depth data from each position of the face of the first user to the external display screen 124, through the image sensor and the depth sensor oriented towards the face of the first user, and generates a 3D facial image with depth information, according to the image data and the first depth data.

In some embodiments, the above-mentioned depth sensor can be configured on the inner side of the head mounted display device 10, to collect the first depth data of the face of the first user in real-time, and update the facial image of the first user, in combination with the real-time collected first depth data and real-time collected facial image data.

Alternatively, in other embodiments, the above-mentioned depth sensor can also be an external device such as a mobile phone, which is arranged on the outer side of the head mounted display device 10, to perform pre-modeling of the face of the first user, by pre-collecting and storing first depth data from each position of the face of the first user to the external display screen 124, and then update the facial image of the first user, by performing facial countenance tracking in combination with real-time collected facial image data.

Furthermore, in some embodiments, the facial image generator 121 can preferably be configured with a first interpolation table for compressing and storing 3D facial image information of the first user, thereby reducing the required storage space. In this way, after obtaining a 3D facial image of the first user from a single view angle, the facial image generator 121 can also interpolate the 3D facial image from the single view angle according to the first interpolation table, to obtain 3D facial images from a plurality of view angles.

Please refer to FIG. 4 for details, FIG. 4 shows a schematic diagram of a facial image divided by triangular meshes provided according to some embodiments of the disclosure.

In the embodiment shown in FIG. 4, the above-mentioned first interpolation table is divided by triangular meshes, and stores texture coordinates, spatial coordinates and mesh information of a plurality of mesh vertices. When interpolating the 3D facial image from a single view angle, the facial image generator 121 can firstly determine a corresponding triangular mesh for each of a plurality of first pixel points in the 3D facial image from the single view angle, according to pixel indices of the plurality of first pixel points, and the spatial coordinates and the mesh information of each of the plurality of mesh vertices stored in the first interpolation table, and then perform triangular interpolation, according to the texture coordinates of the mesh vertices of each of the triangular meshes, and relative positions between each of the plurality of first pixel points and corresponding mesh vertices, to separately determine the texture coordinates of a plurality of second pixel points in each of the triangular meshes from the corresponding view angle. Afterwards, the facial image generator 121 can separately determine the 3D facial image from the corresponding view angle, according to the texture coordinates of the plurality of first pixel points and the plurality of second pixel points from the plurality of the view angles. Afterwards, the facial image generator 121 can transfer the 3D facial images from the plurality of view angles to the layer mixer, to separately perform layer mixing with the externally displayed image from a corresponding view angle, to generate the mixed image from a plurality of view angles.

In this way, the disclosure can achieve a naked-eye 3D visual effect, by dividing the human face by triangular meshes, to respectively present the textures of each of the triangular meshes at the corresponding view angle in each light-emitting direction. In addition, the disclosure can significantly reduce the storage space required for multi-view 3D facial images, by compressing the information of the entire human face into information related to mesh vertices, thereby reducing the hardware cost of the head mounted display device 10, and enhancing the supported display accuracy.

Those skilled in the art can understand that the embodiment of interpolating the 3D facial image from the single view angle based on a first interpolation table, to generate the 3D facial images from a plurality of view angles described above is only a non-limiting embodiment provided by the disclosure, aiming to clearly demonstrate the main concept of the disclosure and provide a specific solution for public implementation, rather than limiting the scope of protection of the disclosure.

Optionally, in other embodiments, those skilled in the art can also configure a plurality of sets of image sensors and depth sensors, to similarly achieve the technical effect of generating the 3D facial images from a plurality of view angles.

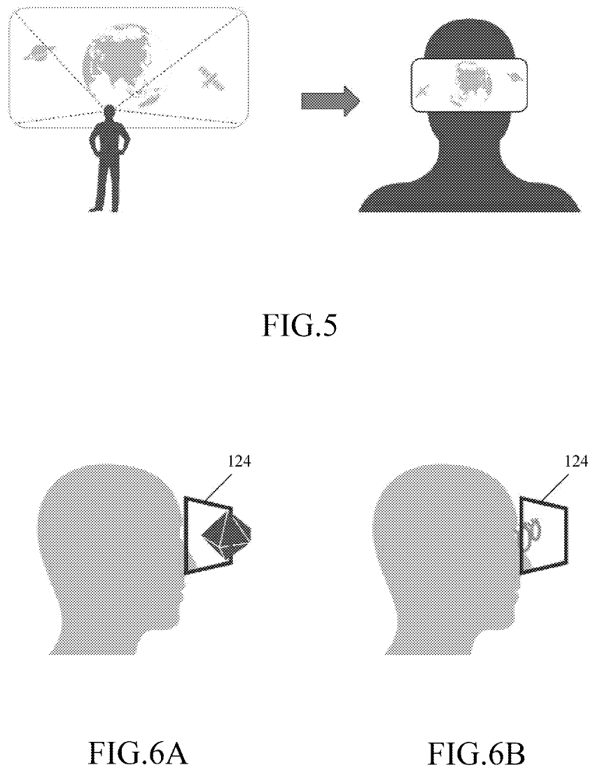

In addition, please refer to FIG. 5. FIG. 5 shows a schematic diagram of generating a mirrored externally displayed image provided according to some embodiments of the disclosure.

As shown in FIG. 5, during the process of generating the externally displayed image, the display image generator 122 can obtain internal display data such as a 2D user interface image displayed to the first user wearing the head mounted display device 10 from the internal display system 11 of the head mounted display device 10 as described above, and perform mirroring processing on it, to generate a mirrored externally displayed image, thereby presenting the field of view image displayed to the first user in the form of a mirror-reflected image via a curved or planar external display screen 124, to provide the external second user with a visual impression of a snow-mirrored external scene.

In addition, please refer to FIG. 6A and FIG. 6B. FIG. 6A and FIG. 6B show schematic diagrams of three-dimensional objects provided according to some embodiments of the disclosure.

As shown in FIG. 6A and FIG. 6B, the externally displayed image can also preferably comprise a 3D virtual object image with depth information. Specifically, in the process of generating the 3D virtual object image, the display image generator 122 can firstly generate a virtual object image to be displayed, determine corresponding second depth data thereof. Herein, the virtual object image includes, but is not limited to, a solid geometric image such as sphere, polygonal prism, and polygonal pyramid, and a simulated or cartoon solid image of a virtual object such as a glass, a toy, a table, and a chair. The second depth can be less than the standard depth (for example 0) corresponding to the external display screen 124, to highlight the external display screen 124, or greater than the standard depth corresponding to the external display screen 124, to be recessed into the external display screen 124. Then, the display image generator 122 can generate the 3D virtual object image with depth information according to the virtual object image and the corresponding second depth data.

Furthermore, for the above-mentioned 3D virtual object image with depth information, the display image generator 122 can also be preferably configured with a second interpolation table corresponding to the 3D virtual object image. In response to generating the 3D virtual object image from a single view angle, the display image generator can also preferably interpolate the 3D virtual object image from a single view angle, according to the second interpolation table, to obtain 3D virtual object images from a plurality of view angles.

Furthermore, the above-mentioned second interpolation table is divided by triangular meshes, and stores texture coordinates, spatial coordinates and mesh information of a plurality of mesh vertices in the 3D virtual object image. When interpolating the 3D virtual object image from a single view angle, the display image generator 122 can firstly determine the triangular mesh corresponding to each first pixel point according to the pixel indices of the plurality of first pixel points in the 3D virtual object image from a single view angle, and the spatial coordinates and the mesh information of each the plurality of mesh vertices stored in the second interpolation table, and then performs triangular interpolation, according to the texture coordinates of the mesh vertices of each of the triangular meshes, and the relative positions between each of the plurality of first pixel points and corresponding mesh vertices, to separately determine the texture coordinates of a plurality of second pixel points in each of the triangular meshes from the corresponding view angle. Then, the display image generator 122 can determine the 3D virtual object image from the corresponding perspective according to the texture coordinates of the first pixel point and the plurality of second pixel points from the plurality of the view angles. Afterwards, the display image generator 122 can transfer the 3D virtual object images from the plurality of view angles to the layer mixer 123, and perform layer mixing on the facial images from the corresponding view angles to generate the mixed images from the plurality of view angles.

In this way, the disclosure can achieve a naked-eye 3D visual effect, by dividing the human face by triangular meshes, to respectively present the textures of each of the triangular meshes at the corresponding view angle in each light-emitting direction. In addition, the disclosure can significantly reduce the storage space required for multi-view 3D facial images, by compressing the information of the entire human face into information related to mesh vertices, thereby reducing the hardware cost of the head mounted display device 10, and enhancing the supported display accuracy.

Those skilled in the art can understand that although an embodiment in which the display image generator 122 generates a 3D virtual object image by itself is described above, this is only a non-limiting embodiment provided by the disclosure, aiming to clearly demonstrate the main concept of the disclosure and provide a specific solution for public implementation, rather than limiting the scope of protection of the disclosure.

Optionally, in other embodiments, the internal display system 11 of the head mounted display device 10 with a mixed reality (MR) display function can also generate a 3D virtual object image, and display the 3D virtual object image to the first user wearing the head mounted display device 10 via the internal display screen 111. For this, the display image generator 122 can directly obtain the displayed 3D virtual object image and the corresponding second depth data from the internal display system 11, and generate a 3D virtual object image for the external second user to observe the virtual object accordingly, to further reduce the data processing load of the external display system 12, by reusing the image data and the second depth data of the virtual object.

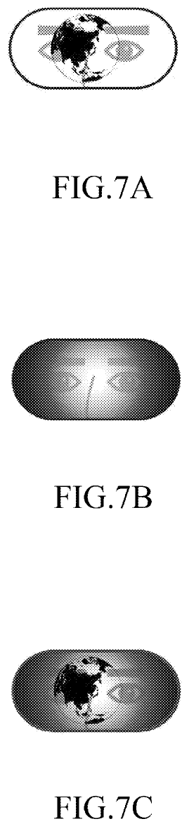

Please refer to FIG. 7A to FIG. 7C, Fig. FIG. 7A to FIG. 7C show schematic diagrams of a mixed image provided according to some embodiments of the disclosure.

As shown in FIG. 7A to FIG. 7C, after generating the facial image and the externally displayed image, the layer mixer 123 can perform layer mixing on at least two images among a 2D or 3D facial image, a 2D externally displayed image, and the 3D virtual object image according to depth and transparency, to generate the mixed image.

For example, in the embodiment shown in FIG. 7A, the layer mixer 123 can perform layer mixing on the 2D or 3D facial image and a 3D virtual earth image, to obtain a corresponding first mixed image.

For another example, in the embodiment shown in FIG. 7B, the layer mixer 123 can perform layer mixing on the 2D or 3D facial image, and a mirrored 2D user interface image, to obtain a corresponding second mixed image.

For another example, in the embodiment shown in FIG. 7C, the layer mixer 123 can perform layer mixing on the 2D or 3D facial image, the mirrored 2D user interface images, and the 3D virtual earth image, to obtain a corresponding third mixed image.

Furthermore, for the specific applications of the mixed 3D facial image and the 3D virtual object image shown in FIG. 7A and FIG. 7C, the layer mixer 123 can preferably be configured with a first lookup table corresponding to first depth of the 3D facial image, and a second lookup table corresponding to second depth of the 3D virtual object image. When performing layer mixing on the 3D facial image and the 3D virtual object image, the layer mixer 123 can perform layer mixing based on depths of the 3D facial image and the 3D virtual object image, according to the first lookup table and the second lookup table, adjusting display content and display position of the 3D facial image and/or the 3D virtual object image, to generate a 2D mixed image with 3D visual effect.

Specifically, during the process of performing layer mixing, the layer mixer 123 can firstly determine an occlusion relationship between a plurality of layers such as the 3D facial image, the 3D virtual object image, and/or the 2D user interface image according to the first depth of the 3D facial image, the second depth of the 3D virtual object image, and/or the third depth of the 2D user interface image. Then, the layer mixer 123 can determine an occlusion area of an upper-layer image with respect to a lower-layer image from a plurality of view angles, according to a spatial position of at least one non-transparent object in the upper image compared to the lower image. Afterwards, the layer mixer 123 can query the first lookup table for the 3D facial image and the second lookup table for the 3D virtual object image, to adjust the display positions of various objects in the 3D facial image and/or the 3D virtual object image, use the non-transparent object in the upper-layer image to occlude the occlusion areas of the lower-layer image, and display or supplement the display content of the exposed areas of the lower-layer image at the corresponding view angle, to generate a 2D mixed image with a 3D visual effect.

Furthermore, in the layer mixing application involving the mirrored 2D user interface image shown in FIG. 7C, the layer mixer 123 can firstly obtain the 3D virtual object image and the corresponding second depth and second transparency thereof, and the mirrored 2D user interface image and corresponding third transparency thereof, and the third depth corresponding to the external display screen 124. Then, the layer mixer 123 can perform layer mixing on the facial image, the virtual object image, and the mirrored user interface image according to the first depth corresponding to the facial image, the second depth and the second transparency corresponding to the 3D virtual object image, and the third depth and the third transparency corresponding to the mirrored 2D user interface image, to generate a mixed image.

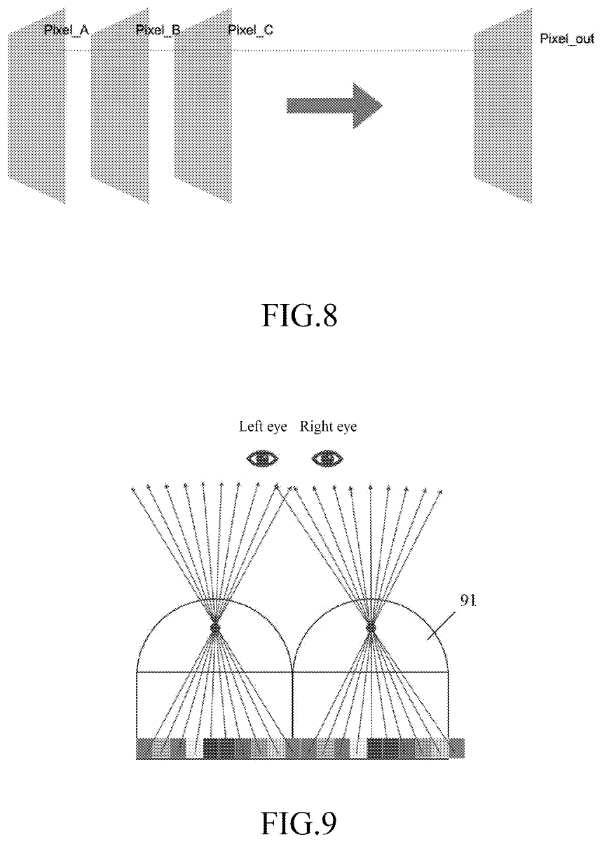

In addition, please refer to FIG. 8. FIG. 8 shows a schematic diagram of pixel-level layer mixing provided according to some embodiments of the disclosure.

In the embodiment shown in FIG. 8, the layer mixer 123 can also preferably be connected to an ambient light sensor. During the process for performing pixel-level layer mixing on the 3D facial image, the externally displayed image, and the 3D virtual object image, for pixel point Pixelₒᵤₜ(x, y), the layer mixer 123 can firstly determine a second brightness C₀(x, y) of a second layer where the 3D virtual object image is located, according to an effect requirement of a virtual object layer, determine a third brightness B₀(x, y) of a third layer where the mirrored 2D user interface image is located, according to an artistic effect requirement, and obtain an ambient light signal via the ambient light sensor.

Then, the layer mixer 123 can determine a first brightness adjustment coefficient Lₐ, according to the ambient light signal and a reflection coefficient of human skin, and determine the first brightness A₁(x, y) of the first layer where the facial image is located through multiplication operation, by combining an image brightness A₀(x, y) captured by a virtual human facial countenance camera.

In addition, the layer mixer 123 can also obtain the ambient light signal according to the ambient light sensor, determine a third brightness adjustment coefficient L_{b}, and adjust the above-mentioned third brightness B₀(x, y) accordingly, and determine a third corrected brightness B₁(x, y) through multiplication operation.

In addition, the layer mixer 123 can also obtain the ambient light signal according to the ambient light sensor, determine a second brightness adjustment coefficient L_{c}, and adjust the above-mentioned second brightness C₀(x, y) accordingly, and determine a second corrected brightness C₁(x, y) through multiplication operation.

Afterwards, the layer mixer 123 can perform layer mixing on the 3D facial image, the 3D virtual object image, and the mirrored 2D user interface image, according to the above-mentioned first brightness A₁(x, y), the third corrected brightness B₁(x, y), the second corrected brightness C₁(x, y), to generate the mixed image with a corresponding brightness.

Furthermore, during the process of performing pixel-level layer mixing on the 3D facial image, the externally displayed image, and the 3D virtual object image, the layer mixer 123 can also preferably determine a first occlusion attenuation coefficient BA(x, y) of the third layer to the first layer, according to the third transparency design of a UI layer display image of the third layer, determine a second occlusion attenuation coefficient CA(x, y) of the second layer to the first layer, according to a second transparency design of the virtual object of the second layer, and determine the third occlusion attenuation coefficient CB(x, y) of the second layer to the third layer.

Then, the layer mixer 123 can determine a first adjustment value alphaA(x, y) of the first layer, according to the first brightness adjustment coefficient Lₐ, the first occlusion attenuation coefficient BA(x, y), and the second occlusion attenuation coefficient CA(x, y) related to the ambient light signal through multiplication operation, determine a third adjustment value alphaB(x, y) of the third layer, according to the third brightness adjustment coefficient L_{b} and the third occlusion attenuation coefficient CB(x, y) related to the ambient light signal through multiplication operation, and determine a second adjustment value alphaC(x, y) of the second layer, according to the second brightness adjustment coefficient L_{c} related to the ambient light signal.

Afterwards, the layer mixer 123 can calculate a grayscale value of a corresponding pixel point (x, y) in the generated mixed image, according to the grayscale values Pixel_{A}, Pixel_{B}, Pixel_{C} of the corresponding pixel point in each layer, and the corresponding first adjustment value alpha_{A}, the third adjustment value alphaB, and the second adjustment value alphaC:

$${Pixel}_{out} = {Pixel}_{A} \times alphaA + {Pixel}_{B} \times alphaB + {Pixel}_{C} \times alphaC .$$

And preferably determine a maximum brightness value Lₘₐₓ of the generated mixed image, according to the grayscale value of the pixel point in each layer, and the occlusion attenuation coefficients BA(x, y), CA(x, y), CB(x, y) of each upper-layer to its lower-layer. As an example, the calculation method for Lₘₐₓ is as follows:

$${L}_{m ax} = max ( {A}_{1} \times BA \times CA + {B}_{1} \times CB + {C}_{1} ) .$$

Afterwards, whenever a new mixed image is generated, the layer mixer 123 can determine whether a maximum brightness value Lₘₐₓ of the mixed image is greater than a maximum display brightness L_{p max} of the external display screen 124. In response to a judgment result that the maximum brightness value Lₘₐₓ of the mixed image is greater than the maximum display brightness L_{p max} of the external display screen 124, the layer mixer 123 can further determine a tone mapping value TM[GL₀(x, y)] for each layer according to a ratio of the maximum brightness value Lₘₐₓ of the mixed image to the maximum display brightness L_{p max} of the external display screen 124, and perform color tone mapping (TM) on RGB grayscale values of each pixel in the mixed image, according to the tone mapping value TM[GL0(x, y)], the first adjustment value alphaA(x, y), the second adjustment value alphaC(x, y), and the third adjustment value alphaB(x, y), so as to make the maximum brightness value less than or equal to the maximum display brightness of the external display screen, i.e. Lₘₐₓ≤L_{p max} As an example, the original RGB grayscale values of each pixel point (x, y) in the mixed image can be calculated using the following formula:

$${GL}_{0} ( x , y ) = {GL}_{A} ( x , y ) \times alphaA ( x , y ) + {GL}_{B} ( x , y ) \times alphaB ( x , y ) + {GL}_{C} ( x , y ) \times alphaC ( x , y ) .$$

The grayscale values of each pixel in the mixed image after tone mapping can be represented as:

$${GL}_{1} ( x , y ) = {GL}_{0} ( x , y ) \times TM [ {GL}_{0} ( x , y ) ] .$$

In this way, in the embodiment shown in FIG. 7A to FIG. 7C, due to the different transparency of different areas of the layers, during the process of performing mixing on the images, the layer mixer 123 can overlay the 3D facial image layer with a 2D user interface image with uneven transparency and a partially transparent 3D virtual object layer, thereby partially or completely occluding the underlying 3D facial image by using the low-transparency edges of the 2D user interface and the opaque 3D virtual object. The disclosure can more flexibly implement a layer superimposition function, by performing pixel-level layer mixing display, thereby displaying incomplete occlusion between layers to optimize user experience.

Please continue to refer to FIG. 1 and FIG. 2. After generating the mixed image, the external display system 12 can display the mixed image to the external second user through the external display screen 124 located on the outer side of the head mounted display device 10 and facing away from the face of the first user.

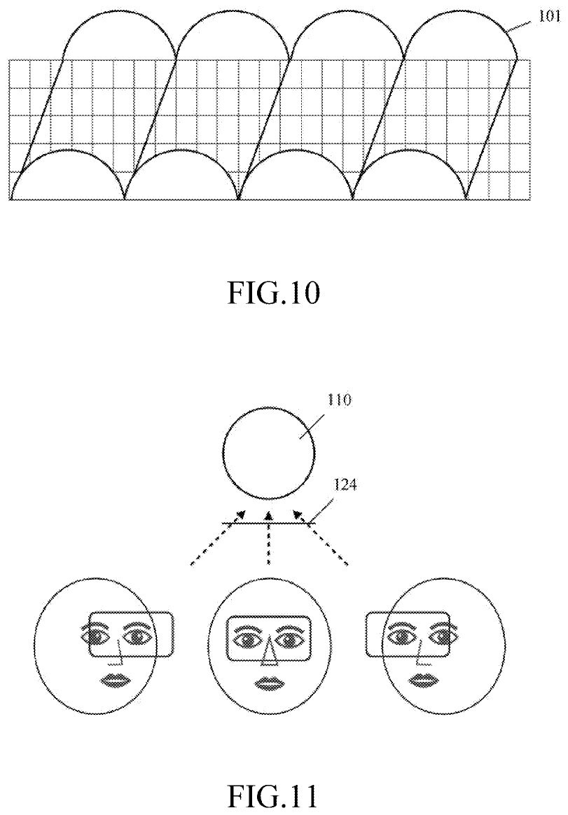

Furthermore, please refer to FIG. 9 to FIG. 11. FIG. 9 shows a schematic diagram of an external display screen with a plurality of view angles display provided according to some embodiments of the disclosure. FIG. 10 shows a schematic diagram of microlens array units provided according to some embodiments of the disclosure. FIG. 11 shows a schematic diagram of a plurality of view angles display provided according to some embodiments of the disclosure.

In the embodiment shown in FIG. 9, the external display screen 124 can preferably be configured with a microlens array 91 composed of a plurality of microlens units. When displaying the mixed image to an external second user, the external display screen 124 can obtain 3D facial images from a plurality of view angles, 3D virtual object images from a plurality of view angles, and/or mixed images from a plurality of view angles, and control light emitted to corresponding directions by each pixel unit in the external display screen according to the view angles of each of the 3D facial images, each of the 3D virtual object images and/or each of the mixed images, via the microlens array 91, to display a corresponding mixed image to a direction of each of the plurality of view angles.

Furthermore, in the embodiment shown in FIG. 10, the disclosure can preferably arrange each of the plurality of microlens unit 101 in a cylindrical shape, with a long side direction thereof being different from the column direction of the pixel units of the external display screen 124, and each of the microlens unit 101 corresponding to a non-integer number of pixel units, so that the angular directions refracted by each pixel point are densely and uniformly distributed in space, thereby eliminating the discontinuity phenomenon when the view angle of the user switches.

Furthermore, in some embodiments, the external display system 12 provided in the first aspect of the disclosure can preferably further comprise a feedback unit. When externally displaying the mixed image, the external display system 12 can also sense an audience position of at least one external audience through the feedback unit, and adjust a display mode of the mixed image according to an audience position of the at least one external audience.

In this way, as shown in FIG. 11, the optical cylindrical lens on the external display screen 124 can confine the light emitted by each pixel to a specific direction, and display optical signals of corresponding angles to the external second user according to different relative positions between the external second user and the cylindrical lens, to achieve an effect that the user at different field angles can see different pictures respectively. For example, a second user located on a left side of the first user 110 can observe a left face image of the first user 110 from the external display screen 124, a second user located directly in front of the first user 110 can simultaneously observe a front face image of the first user 110 from the external display screen 124, and a second user located on a right side of the first user 110 can simultaneously observe a right face image of the first user 110 from the external display screen 124.

Those skilled in the art can understand that the embodiment shown in FIG. 1 in which the external display system 12 and the internal display system 11 are both configured in the head mounted display device 10 is only one non-limiting embodiment provided by the disclosure, aiming to clearly demonstrate the main concept of the disclosure and provide a specific solution taking a human being as the first user, rather than limiting the scope of protection of the disclosure.

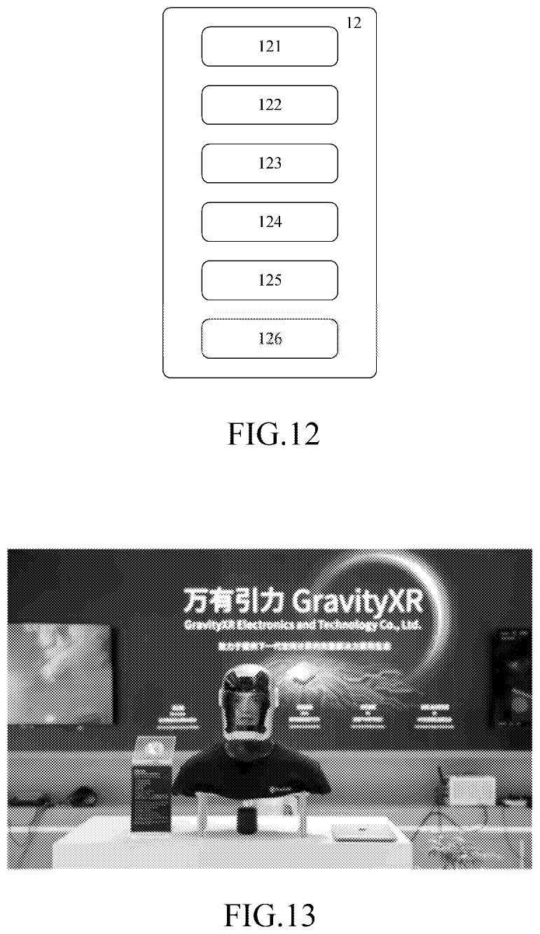

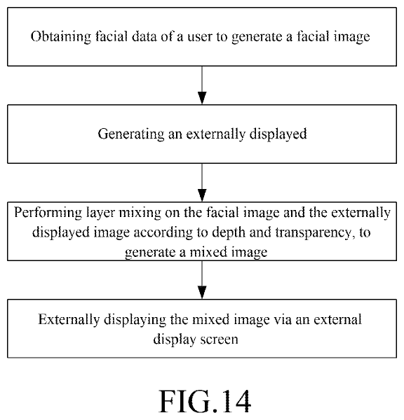

Optionally, please refer to FIG. 12 to FIG. 14. FIG. 12 shows a schematic diagram of an external display system provided according to some embodiments of the disclosure. FIG. 13 shows a schematic diagram of an external display scene provided according to some embodiments of the disclosure. FIG. 14 shows a flowchart of a controlling method for an external display system provided according to some embodiments of the disclosure.

In the embodiments shown in FIG. 12 to FIG. 14, the above-mentioned first user can also be a robot. Correspondingly, the external display system 12 does not need to be connected to the internal display system 11, but can be directly configured on the head or other positions of the robot in the form of a head mounted display device or a head display module as shown in FIG. 13, thereby achieving externally display of a facial countenance of the robot and the corresponding mixed image of display content through the external display screen 124, facilitating communication and interaction between an external individual (i.e. the second user) and the robot.

In addition, in some embodiments, the above-mentioned first user can also be a digital avatar based on a metaverse scene. Correspondingly, the external display system 12 does not need to be connected to the above-mentioned internal display system 11, but is directly integrated into an extended reality (XR) display device of the digital avatar, thereby achieving external display of a facial countenance of the digital avatar and the corresponding mixed image of display content through the external display screen 124, facilitating communication and interaction between the external individual (i.e. the second user) and the digital avatar.

As shown in FIG. 12 and FIG. 14, in a scene where the robot or the digital avatar is taken as the first user, there can be no need to internally display images to the first user (i.e. the robot or the digital avatar). Correspondingly, the display image generator 122 does not need to obtain internal display data for the first user, but directly generates a corresponding externally displayed image according to content to be displayed to the external individual (i.e. the second user) as required.

In addition, the facial image generator 121 can obtain facial data of the first user (i.e. the robot or the digital avatar), to generate a facial image. Herein, the facial image is a static facial image, or a dynamic facial countenance image. The facial image generator 121 can perform pre-modeling of the face of the first user, by pre-collecting and storing first depth data from each position of the face of the first user to the external display screen 124, and update the facial image of the first user, by performing facial countenance tracking in combination with real-time collected facial image data.

Then, the layer mixer 123 can perform layer mixing on the facial image and the externally displayed image, according to the depth and the transparency of the externally displayed image and the depth and the transparency of the facial image, to generate a mixed image, and display the mixed image of the face of the robot or the digital avatar and a displayed content to the external individual (i.e. the second user) via the external display screen 124, facilitating communication and interaction between the external individual (i.e. the second user) and the robot or the digital avatar.

Specifically, during the process of performing mixing on the two-layer image of a facial layer A and a virtual object layer C of the robot, the layer mixer 123 can firstly obtain a current ambient light intensity through the ambient light sensor, and determine the first brightness adjustment coefficient Lₐ, in combination with the reflection coefficient of facial material or display surface of the robot, and determine the first brightness A₁(x, y) of each pixel of the facial layer A under the current ambient light conditions, in combination with an image brightness A₀(x, y) of the image captured by the virtual human facial countenance camera.

In addition, the layer mixer 123 can determine the original second brightness C₀(x, y) of virtual object layer C, according to display effect requirements of the virtual object (such as virtual emoticons, prompt information, or decorative 3D objects), obtain the ambient light signal according to the ambient light sensor, determine the second brightness adjustment coefficient L_{c}, adjust the above-mentioned second brightness accordingly, and determine the second corrected brightness C₁(x, y) of the virtual object layer C through multiplication operation.

Afterwards, the layer mixer 123 can determine the occlusion attenuation coefficient CA(x, y) of each pixel point in the virtual object layer C for the face of the robot, according to a transparency design of the virtual image, and calculate the overall brightness maximum value required for each layer for the entire screen accordingly:

Lₘₐₓ=max(A₁×CA+C₁) In addition, the layer mixer 123 can determine the first adjustment value alphaA(x, y) of the facial layer A by multiplying the first brightness adjustment coefficient Lₐ related to the ambient light signal and the above-mentioned occlusion attenuation coefficient CA(x, y), and determine the second adjustment value alphaC(x, y) of the virtual object layer C, according to the second brightness adjustment coefficient L_{c} related to the ambient light signal.

Afterwards, whenever a new mixed image is generated, the layer mixer 123 can determine whether a maximum brightness value Lₘₐₓ of the mixed image is greater than a maximum display brightness L_{p max} of the external display screen 124. In response to a judgment result that the maximum brightness value Lₘₐₓ of the mixed image is greater than the maximum display brightness L_{p max} of the external display screen 124, the layer mixer 123 can further determine a tone mapping value TM[GL₀(x, y)] for each layer according to a ratio of the maximum brightness value Lₘₐₓ of the mixed image to the maximum display brightness L_{p max} of the external display screen 124, and perform color tone mapping (TM) on RGB grayscale values of each pixel in the mixed image, according to the tone mapping value TM[GL₀(x, y)], the first adjustment value alphaA(x, y), and the second adjustment value alphaC(x, y), so as to make the maximum brightness value less than or equal to the maximum display brightness of the external display screen, i.e. Lₘₐₓ≤L_{p max} As an example, the original RGB grayscale values of each pixel point (x, y) in the mixed image can be calculated using the following formula:

$${GL}_{0} ( x , y ) = {GL}_{A} ( x , y ) \times alphaA ( x , y ) + {GL}_{C} ( x , y ) \times alphaC ( x , y ) .$$

The grayscale values of each pixel (x, y) in the mixed image after tone mapping can be represented as:

$${GL}_{1} ( x , y ) = {GL}_{0} ( x , y ) \times TM [ {GL}_{0} ( x , y ) ] .$$

In this way, due to the different transparency of different areas of the layers, during the process of performing mixing on the images, the layer mixer 123 can overlay a partially transparent 3D virtual object layer on top of the 3D facial image layer, thereby using the opaque 3D virtual object to partially or completely occlude the underlying 3D facial image. The disclosure can more flexibly implement a layer superimposition function, by performing pixel-level layer mixing display, thereby displaying incomplete occlusion between layers to optimize user experience.

Furthermore, in some embodiments, the display image generator 122 can determine a virtual object category feature and/or a display effect feature that need to be displayed, according to a current interaction scene, and generate the virtual object image corresponding to the interaction scene, according to the virtual object category feature and/or the display effect feature. Herein, the virtual object category feature includes, but is not limited to a graphic dimension of a geometric shape such as a heart, a triangle, and a circle, an icon dimension of a simplified icon such as an emoticon, a prohibition icon, and a waiting icon, and a text dimension of a corresponding explanatory content and an emotional expression. The display effect feature includes, but is not limited to a parameter related to a display effect such as coordinate, depth of field, color, texture, brightness, and transparency.

Specifically, the above-mentioned interaction scene can comprise a scene for an educational companion robot. In homes or educational institutions, the robot can be used to teach or explain knowledge to children. At this time, the facial image generator 121 can generate a three-dimensional cartoon-like facial image to enhance affinity towards children. The display image generator 122 can generate a virtual object related to teaching content, and through the layer mixer 123 and the external display screen 124, achieve the mixed display of the three-dimensional cartoon-like facial image and the related virtual object, in order to enhance concentration of the children, and deepen their understanding of the explained content.

For example, during the process of explaining knowledge related to solar system, the display image generator 122 can correspondingly generate one or more circular geometric shapes, and simulate celestial bodies such as the sun and the earth by reasonably setting display effect characteristics such as color and texture, thereby achieving the mixed display of a celestial body model and a three-dimensional cartoon-like facial image. Furthermore, in some embodiments, the display image generator 122 can also adjust the display effect feature such as the coordinate, the depth of field, and the transparency of the virtual object image periodically over time, further simulating the visual effect of each celestial body model revolving around the facial image, thereby enhancing the interest of teaching.

For another example, during the process of explaining animal knowledge, the display image generator 122 can correspondingly generate one or more virtual cartoon graphics of animals, and dynamically adjust the display effect feature such as the coordinate position and the depth of field of the virtual cartoon graphics, to achieve the visual effects of animals jumping into the field of view from one side of the facial image, jumping out of the field of view from one side of the facial image, and running closer and farther in the field of view in front of the facial image, thereby enhancing the interest of teaching.

For another example, during the process of spelling instruction, the display image generator 122 can correspondingly generate a virtual text image of one or more letters, and achieve a visual effect such as the virtual text image bouncing up, down, forward, and backward in the field of view in front of the facial image, and flickering, by dynamically adjusting the display effect feature such as the coordinate position, the depth of field, and the transparency of the virtual text image, thereby enhancing the fun of teaching.

In addition, in some embodiments, the external display system 12 may further comprise an emotion recognizer 125. The emotion recognizer 125 is configured to determine an emotion of the first user (including but not limited to robots, digital humans, and human beings) according to the current interaction scene, and transfer emotion data indicating the emotion to the backend facial image generator 121 and display image generator 122. The facial image generator 121 can further determine a second expression feature of the facial image according to the emotion of the user, and generate the facial image of the user according to the facial data of the user and the second expression feature, wherein the second expression feature comprises at least one of an emotion feature and an countenance feature.

Furthermore, the display image generator 122 can determine the first expression feature corresponding to the emotion of the first user according to the current interaction scene, and generate the virtual object image associated with the second expression feature of the facial image according to the first expression feature, to achieve the associated display (especially an emotion-enhanced display) of the virtual object image and the facial image.

For example, when the first user (including but not limited to a robot, a digital avatar, and a human) provides public services in a place such as a shopping mall, a hospital, and a bank, the emotion recognizer 125 can determine the emotion of the first user as happy, according to a general interaction scene, and transfer the emotion data indicating happiness to the backend facial image generator 121 and the display image generator 122. The facial image generator 121 can determine the emotion feature and/or the countenance feature of the facial image of the first user, according to the emotion data indicating happiness, and generate a facial image with a smiling countenance, according to the facial data of the first user and the emotion feature and/or the countenance feature.

Correspondingly, the display image generator 122 can determine the first expression feature (such as a star shape or a heart shape, a coordinate position near eyes, a depth parameter and a transparency parameter that change periodically over time) corresponding to the pleasant emotion of the first user, according to the current interaction scene, and generate a virtual object image (i.e. a star shape or a heart shape that moves back and forth near the eye position and flashes) associated with the smiling countenance of the facial image, according to the first expression feature, to achieve emotion enhancement display of the virtual object image and the facial image.

For another example, when the first user (including but not limited to a robot, a digital avatar, and a human) is in an interaction scene of answering questions, the emotion recognizer 125 can determine the emotion of the first user as thinking before the first user provides a reply, and transfer the emotion data indicating thinking to the backend facial image generator 121 and the display image generator 122. The facial image generator 121 can determine the emotion feature and/or the countenance feature of the facial image of the first user, according to the emotion data indicating thinking, and generate a facial image with a slight frown expression, according to the facial data of the first user and the emotion feature and/or the countenance feature.

Correspondingly, the display image generator 122 can determine the first expression feature (such as a question mark icon or a halo icon, the coordinate position on one side of the head, a transparency parameter, a depth parameter that changes periodically over time) corresponding to the thinking emotion of the first user, according to the current interaction scene, and generate a virtual object image (i.e. a semi-transparent question mark icon or a halo icon that rotates back and forth on one side of the head) associated with a slightly frowning facial countenance, according to the first expression feature, to achieve enhanced emotional display of the virtual object image and the facial image.

For another example, when the first user (including but not limited to a robot, a digital avatar, and a human) is in an interaction scene where precautions are being expressed, the emotion recognizer 125 can determine the emotion of the first user as serious, and transfer the emotion data indicating seriousness to the backend facial image generator 121 and the display image generator 122. The facial image generator 121 can determine the emotion feature and/or the countenance feature of the facial image of the first user, according to the emotion data indicating seriousness, and generate a facial image with a serious expression, according to the facial data of the first user and the emotion feature and/or the countenance feature.

Correspondingly, the display image generator 122 can determine the first expression feature (such as a 3D warning icon or a text content, a coordinate position in a center of the face, a color parameter of red, a depth parameter less than the facial depth, a transparency parameter and a brightness parameter that change over time) corresponding to the serious emotion of the first user, according to the current interaction scene, and generate a virtual object image (i.e. a 3D warning icon or text content flashing in the center of the face) associated with a serious expression of the facial image, according to the first expression feature, to achieve an emotion-enhanced display of the virtual object image and facial image.

In addition, in some embodiments, the external display system 12 applied to a robot and a digital avatar as shown in FIG. 12 can further generate a 3D facial image from at least one view angle based on an image sensor, a depth sensor, and/or a first interpolation table corresponding to a specific view angle facing the face of the user, and the specific principles and description of embodiments can be referred to in the embodiments shown in FIG. 1 to FIG. 11, and will not be repeated here.

In addition, in some embodiments, the external display system 12 applied to a robot and a digital avatar as shown in FIG. 12 can further generate a 3D virtual object image from at least one view angle based on the generated virtual object image, the second depth data corresponding to the virtual object image, and/or the second interpolation table corresponding to a specific view angle, and the specific principles and description of embodiments can be referred to in the embodiments shown in FIG. 1 to FIG. 11, and will not be repeated here.

In addition, in some embodiments, the external display screen 124 of the external display system 12 applied to a robot and a digital avatar as shown in FIG. 12 can be configured with a microlens array composed of a plurality of microlens units, and display the different mixed image to a direction of each of the plurality of view angles through the microlens array, and the specific principles and description of embodiments can be referred to in the embodiments shown in FIG. 1 to FIG. 11, and will not be repeated here.

In addition, in some embodiments, the external display system 12 applied to a robot and a digital avatar as shown in FIG. 12 can further be configured with a feedback unit 126, and senses an audience position of at least one external audience, and adjust a display mode of the mixed image according to an audience position of the at least one external audience through the feedback unit 126, and the specific principles and description of embodiments can be referred to in the embodiments shown in FIG. 1 to FIG. 11, and will not be repeated here.

In addition, in some embodiments, the display image generator 122 of the external display system 12 applied to a robot and a digital avatar as shown in FIG. 12 can further generate a mirrored 2D user interface image, and perform layer mixing on at least two of a mirrored 2D user interface image, a 2D or 3D facial image, and a virtual object image through the layer mixer 123, according to depth and transparency, to generate a mixed image for external display, and the specific principles and description of embodiments can be referred to in the embodiments shown in FIG. 1 to FIG. 11, and will not be repeated here.

In summary, the head mounted display device 10 provided in the disclosure not only boasts a vitrified, borderless visual effect, greatly enhancing the aesthetic appeal of products, but also the external display system 12, the controlling method for the head mounted display device and the non-transitory computer-readable storage medium can also display to an external second user a mixed image of the face of the first user wearing the head mounted display device 10 and the internal display content seen by the first user, so that an external individual can simultaneously see the facial countenance and the view of the first user, thereby facilitating normal communication and interaction between the external individual and the first user.

Although the above methods are illustrated and described as a series of actions in order to simplify the explanation, it should be understood and appreciated that these methods are not limited by the order of actions, because according to one or more embodiments, some actions can occur in different order and/or concurrently with other actions from the illustrations and descriptions herein or not illustrated and described herein, but can be understood by those skilled in the art.

Those skilled in the art will understand that information, signals and data can be represented using any of a variety of different technologies and techniques. For example, the data, instructions, commands, information, signals, bits, symbols and chips cited throughout the above description may be represented by voltage, current, electromagnetic waves, magnetic fields or magnetic particles, optical fields or optical particles, or any combination thereof.

Those skilled in the art will further appreciate that various illustrative logic blocks, modules, circuits and algorithm steps described in combination with the embodiments disclosed herein can be implemented as electronic hardware, computer software or a combination of both. In order to clearly explain the interchangeability of hardware and software, various illustrative components, blocks, modules, circuits and steps are generally described above in the form of their functionality. Whether such functionality is implemented as hardware or software depends on the specific application and design constraints imposed on the overall system. Technicians can implement the described functionality in different ways for each specific application, but such implementation decisions should not be interpreted as leading to departure from the scope of the invention.

The various illustrative logic modules and circuits described in connection with the embodiments disclosed herein can be realized or executed by general-purpose processors, digital signal processors (DSPs), application specific integrated circuits (ASICs), field programmable gate arrays (FPGAs) or other programmable logic devices, discrete gate or transistor logic, discrete hardware components or any combination thereof designed to perform the functions described herein. The general processor can be a microprocessor, but in the alternative, the processor can be any conventional processor, controller, microcontroller or state machine. The processor can also be implemented as a combination of computing devices, such as a combination of DSP and microprocessors, a plurality of microprocessors, one or more microprocessors cooperating with the DSP core or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor so that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software as a computer program product, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blue-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be apparent to those skilled in the art, and the universal principles defined herein can be applied to other variants without departing from the spirit or scope of the disclosure. Therefore, this disclosure is not intended to be limited to the examples and designs described herein, but should be granted the widest scope consistent with the principles and novel features disclosed herein.

What is claimed is:

1. An external display system, comprising:
a facial image generator, used to obtain facial data of a user to generate a facial image;
a display image generator, used to generate an externally displayed image;
a layer mixer, used to perform layer mixing on the facial image and the externally displayed image according to depth and transparency, to generate a mixed image; and
an external display screen, used to externally display the mixed image.

2. The external display system according to claim 1, wherein the facial image generator is connected to at least one image sensor and at least one depth sensor, wherein
the image sensor is oriented towards face of the user, to collect image data of the face of the user,
the depth sensor is oriented towards the face of the user, to collect first depth data of the face of the user,
the facial image generator generates a 3D facial image with depth information, according to the image data and the first depth data of the face of the user.

3. The external display system according to claim 2, wherein the facial image generator is further configured with a first interpolation table, and the facial image generator is further configured to:
interpolate a 3D facial image from a single view angle according to the first interpolation table, to obtain 3D facial images from a plurality of view angles; and
transfer the 3D facial images from the plurality of view angles to the layer mixer, to separately perform layer mixing with the externally displayed image from a corresponding view angle.

4. The external display system according to claim 3, wherein the first interpolation table is divided by triangular meshes, and stores texture coordinates, spatial coordinates and mesh information of a plurality of mesh vertices, and the interpolate a 3D facial image from a single view angle according to the first interpolation table, to obtain 3D facial images from a plurality of view angles comprises:
separately determine a corresponding triangular mesh for each of a plurality of first pixel points in the 3D facial image from the single view angle, according to pixel indices of the plurality of first pixel points, and the spatial coordinates and the mesh information of each of the plurality of mesh vertices stored in the first interpolation table;
perform triangular interpolation, according to the texture coordinates of the mesh vertices of each of the triangular meshes, and relative positions between each of the plurality of first pixel points and corresponding mesh vertices, to separately determine the texture coordinates of a plurality of second pixel points in each of the triangular meshes from the corresponding view angle; and
separately determine the 3D facial image from the corresponding view angle, according to the texture coordinates of the plurality of first pixel points and the plurality of second pixel points from the plurality of the view angles.

5. The external display system according to claim 1, wherein the externally displayed image comprises a 3D virtual object image with depth information, wherein
the display image generator is configured to generate a virtual object image to be displayed, determine corresponding second depth data thereof, and generate the 3D virtual object image according to the virtual object image to be displayed and the second depth data,
the layer mixer is configured to perform layer mixing on a 2D or 3D facial image and the 3D virtual object image according to depth and transparency, to generate the mixed image.

6. The external display system according to claim 5, wherein the display image generator is further configured with a second interpolation table corresponding to the 3D virtual object image, and the display image generator is further configured to:
interpolate the 3D virtual object image from a single view angle according to the second interpolation table, to obtain 3D virtual object images from a plurality of view angles.

7. The external display system according to claim 6, wherein the layer mixer is configured with a first lookup table corresponding to first depth of the 3D facial image, and a second lookup table corresponding to second depth of the 3D virtual object image, and is configured to:
perform layer mixing based on depths of the 3D facial image and the 3D virtual object image, according to the first lookup table and the second lookup table, adjusting display content and display position of the 3D facial image and/or the 3D virtual object image, to generate a 2D mixed image with 3D visual effect.

8. The external display system according to claim 7, wherein the external display screen is configured with a microlens array composed of a plurality of microlens units, and is configured to:
obtain 3D facial images from a plurality of view angles, and 3D virtual object images from a plurality of view angles; and
control light emitted to corresponding directions by each pixel unit in the external display screen according to the view angles of each of the 3D facial images and each of the 3D virtual object images, via the microlens array, to display a corresponding mixed image to a direction of each of the plurality of view angles.

9. The external display system according to claim 8, wherein the plurality of microlens units are cylindrical, and a long side direction thereof is different from a column direction of the pixel units of the external display screen, and each of the microlens units corresponds to a non-integer number of the pixel units.

10. The external display system according to claim 8, wherein the external display system further comprises a feedback unit, used to sense an audience position of at least one external audience, and adjust a display mode of the mixed image according to an audience position of the at least one external audience.

11. The external display system according to claim 1, wherein the display image generator is configured to:
determine a first expression feature of a corresponding virtual object based on a current interaction scene, wherein the first expression feature comprises at least one of a virtual object category feature and a display effect feature; and
generate the virtual object image corresponding to the current interactive scene, according to the first expression feature.

12. The external display system according to claim 11, wherein the external display system further comprises an emotion recognizer, and the emotion recognizer is configured to determine an emotion of the user according to the current interaction scene,
the facial image generator is configured to determine a second expression feature of the facial image according to the emotion of the user, and generate the facial image of the user according to the facial data of the user and the second expression feature, wherein the second expression feature comprises at least one of an emotion feature and an countenance feature,
the display image generating module is further configured to determine the first expression feature corresponding to the emotion of the user according to the current interaction scene, and generate the virtual object image associated with the second expression feature of the facial image according to the first expression feature.

13. The external display system according to claim 1, wherein the external display screen is located on an outer side of a head mounted display device, and faces away from the face of the user wearing the head mounted display device, to externally display the mixed image, and the externally displayed image comprises a mirrored 2D user interface image,
the display image generator is configured to obtain internal display data displayed to the user of the head mounted display device, and perform mirroring processing on the internal display data to generate the mirrored 2D user interface image,
the layer mixer is configured to perform layer mixing on a 2D or 3D facial image and the mirrored 2D user interface image according to depth and transparency to generate the mixed image.

14. The external display system according to claim 13, wherein the externally displayed image further comprises a 3D virtual object image with depth information, the perform layer mixing on a 2D or 3D facial image and the mirrored 2D user interface image according to depth and transparency to generate the mixed image comprises:
obtain the 3D virtual object image, as well as a second depth and a second transparency thereof;
obtain the mirrored 2D user interface image, as well as a third transparency thereof and a third depth corresponding to the external display screen; and
perform layer mixing on the facial image, the 3D virtual object image and the mirrored 2D user interface image, according to a first depth corresponding to the facial image, the second depth, the second transparency, the third depth, and the third transparency.

15. The external display system according to claim 14, wherein the layer mixer is further connected to an ambient light sensor, and is further configured to:
determine a second brightness of a second layer where the 3D virtual object image are located;
determine a third brightness of a third layer where the mirrored 2D user interface image are located;
obtain an ambient light signal via the ambient light sensor;
determine a first brightness of a first layer where the facial image is located according to the ambient light signal, adjust the second brightness to determine a second corrected brightness, and adjust the third brightness to determine a third corrected brightness; and
perform layer mixing on the facial image, the 3D virtual object image and the mirrored 2D user interface image, according to the first brightness, the second corrected brightness and the third corrected brightness, to generate the mixed image.

16. The external display system according to claim 15, wherein the determine a first brightness of a first layer where the facial image is located according to the ambient light signal comprises:
determine a first brightness adjustment coefficient, according to the ambient light signal and a reflection coefficient; and
determine the first brightness of the first layer where the facial image is located through multiplication operation, by combining an image brightness captured by a camera.

17. The external display system according to claim 15, wherein the layer mixer is further configured to:
determine a first occlusion attenuation coefficient of the third layer for the first layer, according to the third transparency of the third layer;
determine a second occlusion attenuation coefficient of the second layer for the first layer, and a third occlusion attenuation coefficient of the second layer for the third layer, according to the second transparency of the second layer;
determine a first adjustment value of the first layer, a second adjustment value of the second layer and a third adjustment value of the third layer, according to the ambient light signal, the first occlusion attenuation coefficient, the second occlusion attenuation coefficient and the third occlusion attenuation coefficient;
in response to generation of the mixed image, determine whether a maximum brightness of the mixed image is greater than a maximum display brightness of the external display screen; and
in response to a judgment result that the maximum brightness of the mixed image is greater than the maximum display brightness of the external display screen, determine a tone mapping value according to a ratio of the maximum brightness of the mixed image to the maximum display brightness of the external display screen, and perform color tone mapping on RGB grayscale values of each pixel in the mixed image, according to the tone mapping value, the first adjustment value, the second adjustment value and the third adjustment value, so as to make the maximum brightness value less than or equal to the maximum display brightness of the external display screen.

18. The external display system according to claim 1, wherein the facial image is a static facial image, or a dynamic facial countenance image, and the facial image generator is further configured to:
perform pre-modeling of the face of the user, by pre-collecting and storing first depth data from each position of the face of the user to the external display screen; and
update the facial image of the user, by performing facial countenance tracking in combination with real-time collected facial image data.

19. A method, comprising:
obtaining facial data of a user to generate a facial image;
generating an externally displayed image;
performing layer mixing on the facial image and the externally displayed image according to depth and transparency, to generate a mixed image; and
externally displaying the mixed image via an external display screen.

20. A non-transitory computer-readable storage medium, having instructions stored thereon, which when executed by one or more processors of a server system cause the processors to perform operations for:
obtaining facial data of a user to generate a facial image;
generating an externally displayed image;
performing layer mixing on the facial image and the externally displayed image according to depth and transparency, to generate a mixed image; and
externally displaying the mixed image via an external display screen.
